(19) United States
(12) Patent Application Publication
(10) Pub. No.: US 2013/0275753 A1
(43) Pub. Date: Oct. 17, 2013

(54) SYSTEM AND METHOD FOR VERIFYING CREDENTIALS

(71) Applicants: Denzil Correa, Mumbai (IN); Ashish Sureka, New Delhi (IN)

(72) Inventors: Denzil Correa, Mumbai (IN); Ashish Sureka, New Delhi (IN)

(73) Assignee: INDRAPRASHTA INSTITUTE OF INFORMATION TECHNOLOGY, New Delhi (IN)

(21) Appl. No.: 13/492,870

(22) Filed: Jun. 10, 2012

(30) Foreign Application Priority Data
Apr. 13, 2012 (IN) 1132/DEL/2012

(51) Int. Cl. H04L 9/32

(52) U.S. Cl. 713/168; 726/4

(57) ABSTRACT

A system and method for verifying credentials are provided. The system includes a credential verification server (102) and a plurality of credential verification local servers (104). The system (100) is configured to receive a request from credential seeker (CS) to verify credentials of a credential owner (CO). The request is forwarded to an appropriate credential verification local server (104) among the plurality of credential verification local servers (104). Thereafter, the credential owner (CO) is notified about the request. Further, instruction is received from the credential owner (CO), wherein the instruction comprises at least one of, denying permission, granting permission to verify credential information as requested by the credential seeker (CS) and granting permission to verify credential information after modifying scope of access to information. Subsequently, access is provided to the credential seeker (CS) to verify credentials based on the instruction received by the credential owner (CO).

### BACKGROUND

1. Field

The disclosed subject matter relates generally to the field of verification of credentials, and, more particularly but not exclusively, to an automated and secure technique for verifying credentials.

2. Discussion of Related Field

Potential employees, who may be referred to as “credential owners”, furnish information corresponding to their education and past work experience, which may be collectively referred to as credentials, to potential employers during the recruitment process. Employers, who may be referred to as “credential seekers”, use such information to shortlist potential employees for interviewing. Further, decision to recruit a potential employee is substantially based on such credentials. Hence, it is needless to say that credential information plays a vital role in making recruitment related decisions. However, empirical data indicates that substantial number of potential employees provide inaccurate information corresponding to their credentials. Hence, employers invest significant resources to investigate the accuracy of the credentials furnished to them, as failing to do so, may lead to higher recruitment costs, undesirable work performance, criminal liabilities, disrepute to organization goodwill and loss of customers, thereby resulting in lower profits and revenues.

Several methodologies have been adopted in the past to verify accuracy of credentials submitted by credential owners to credential seekers. One such methodology that is adopted to verify credentials is labour intensive. In this instant technique, a credential owner submits original or photocopy of certificates of his credentials to a credential seeker. The credential seeker may choose to verify the authenticity of the furnished credentials by contacting the respective authority, such as an educational institute, in case the furnished credentials relates to education in the aforementioned educational institute. The credential seeker may contact the institute by corresponding through phone or email. Alternatively, the credential seeker may visit the institute in-person to have the credentials verified. The institute, after receiving the request from the credential seeker verifies the authenticity of the credentials. The institute enables verification of the credentials by appointing staff, which would be responsible for checking past records to verify credentials. This technique, apart from being labour intensive, is also consumes significant time. Further, since extensive manual intervention is required in this technique, the verification process may be subject to inaccuracies. One such reason that that may lead to inaccurate verification is a scenario wherein, the staff in the institute, which is responsible for carrying out verification, is compromised to provide false verification information. Further, in the instant technique, privacy of the credential owner may be hampered, as unauthorized entities with malignant intentions may use this technique to gather data corresponding to credential owners. In light of the disadvantages associated with such manual techniques, automated systems have been proposed.

Some of the automated techniques that can be used to verify credentials are disclosed in U.S. patent application Ser. Nos. 12/071398, 11/336537, 12/378327 and 09/793854, and U.S. Pat. Nos. 7,263,491 and 8,131,558.

In one of the existing systems, student records are maintained in digital format by educational institutions. The system can be queried via a public network, such as the Internet, and the result is returned to entities querying the system. However, this system does not provide an option for the credentials owners to specifically deny certain requests while accepting others.

Another existing system allows universities to upload educational credentials on third party servers. In this system, credentials owner generates a time frame with a username and password, and the same is communicated to the credentials seeker via e-mail. Hence, this system addresses the problem of not having the option for the credentials owners to specifically deny certain requests while accepting others. However, such solutions, don't take enable credential owner(s) to share (verify) subset of credentials and therefore, a credential owner might eventually disclose some information about himself which he would want to withhold if provided an option. Moreover, in these solutions the university has to share data with third-party services and hence, there are concerns about credentials owner's data privacy.

In light of the foregoing discussion, there is a need for a technique to effectively verify credentials. Further, the technique shall enable credential owners to have increased control over the information they share. Furthermore, the technique shall minimize possibility of credential information being misused.

### SUMMARY

Accordingly the invention provides a system for verifying credentials. The system includes a credential verification server and a plurality of credential verification local servers. The system is configured to receive a request from credential seeker to verify credentials of a credential owner, wherein the request is received by the credential verification server. The request is forwarded to an appropriate credential verification local server among the plurality of credential verification local servers, based on information included in the request. Thereafter, the credential owner is notified about the request, wherein the notification is sent by the credential verification local server. Further, instruction is received from the credential owner, wherein the instruction comprises at least one of, denying permission to verify credential information, granting permission to verify credential information as requested by the credential seeker and granting permission to verify credential information after modifying scope of access to information. Subsequently, access is provided to the credential seeker to verify credentials of the credential owner based on the instruction received by the credential owner.

There is also provided method for verifying credentials. The method includes receiving a request from credential seeker to verify credentials of a credential owner, wherein the request is received by a credential verification server. The request is forwarded to an appropriate credential verification local server among the plurality of credential verification local servers, based on information included in the request. Thereafter, the credential owner is notified about the request, wherein the notification is sent by the credential verification local server. Further, instruction is received from the credential owner, wherein the instruction comprises at least one of, denying permission to verify credential information, granting permission to verify credential information as requested by the credential seeker and granting permission to verify credential information after modifying scope of access to information. Subsequently, access is provided to the credential seeker to verify credentials of the credential owner based on the instruction received by the credential owner.

### BRIEF DESCRIPTION OF DRAWINGS

Embodiments are illustrated by way of example and not limitation in the Figures of the accompanying drawings, in which like references indicate similar elements and in which:

FIG. 1 illustrates a system 100 for verifying credentials, in accordance with an embodiment;

FIG. 2 a block diagram illustrating communication between system 100 and credential owners (CO), and between system 100 and credential seekers (CS), to enable credential verification, in accordance with an embodiment;

FIG. 3 is a flow chart illustrating a method for verifying credentials, in accordance with an embodiment;

FIG. 4 is a flowchart illustrating a method to send a request to a CO for verifying his credentials, in accordance with an embodiment;

FIG. 5 is a flow chart illustrating a method for receiving and processing instructions from the CO, in accordance with an embodiment; and

FIG. 6 is a flow chart illustrating a method for enabling CS to access credential information of CO, after the CO has granted access, in accordance with an embodiment.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Embodiments disclose system and method for verifying credentials. The system may be used in various scenarios, wherein verification of credentials of entities may be desired. One such scenario in which the system may be used is during a recruitment process.

Normally in a recruitment process, a job seeker may submit to a potential employer, information corresponding to his credentials. The potential employer may use the system to verify the authenticity of the credentials information submitted by the job seeker. Further, the job seeker can use the system to control the extent to which his credential information is available for verification to various potential employers.

It shall be noted that, the entities, such as potential employers, who may be interested in verifying credential information, may be referred to as Credential Seekers (CS), and the entities whose credential information may be verified shall be referred to as Credential Owners (CO). Both CS and CO may communicate with the system with their respective communication devices. It shall be noted that the term “CS” may be used to refer to a single or plurality of Credential Seekers, based on the context. Similarly, the term “CO” may be used to refer to a single or plurality of Credential Owners, based on the context.

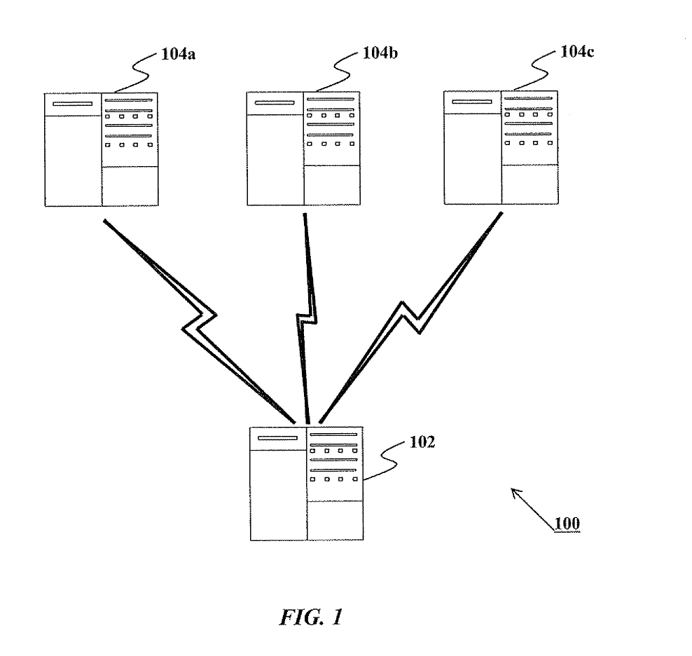

Now referring to FIG. 1, wherein FIG. 1 illustrates a system 100 for verifying credentials, in accordance with an embodiment. System 100 is configured to enable verification of credentials. System 100 includes a Credential Verification Server (CVSₘₐᵢₙ) 102 and plurality of Credential Verification Local. Servers (CVS_{local}) 104a, 104b and 104c. It shall be noted that, the phrase “CVS_{local} 104” may be used to refer to a single or plurality of Credential Verification Local Servers, based on the context.

Each of the CVS_{local} 104 is configured to communicate with CVSₘₐᵢₙ 102. In an embodiment, CVSₘₐᵢₙ 102 may be located at a remote location, and each of CVS_{local} 104 may be located at locations desired by respective institutes, such as education institutes or companies, which have a stake in the credentials earned by CO. For example, an education institute that has awarded a degree to a CO may be considered to have a stake in the credential, which in this case is the degree, earned by the aforementioned CO. In another example, a company in which a CO has worked may be considered to have a stake in the credential, which in this case is the work experience, gained by the aforementioned CO.

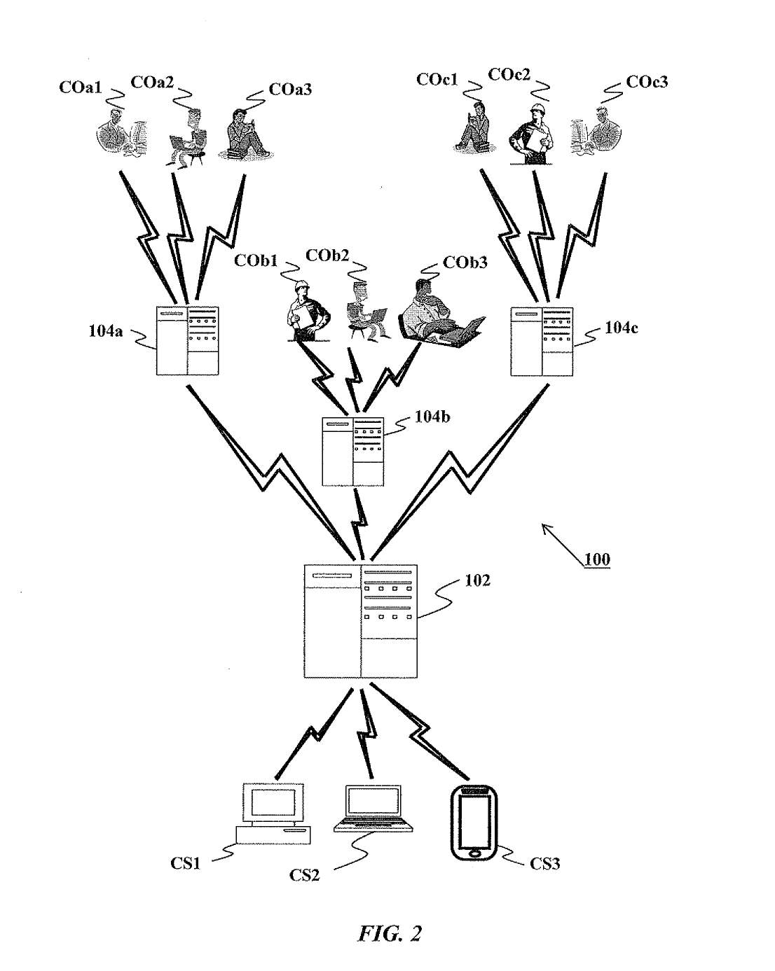

In an embodiment, as illustrated in FIG. 2, credential verification is facilitated by enabling communication between system 100 and CO, and between system 100 and CS. The CO can communicate with CVS_{local} 104 on which they are registered. Similarly, each of the CVS_{local} 104 can communicate with only those CO who are registered with them. It shall be noted that a CO may be registered with one or more CVS_{local} 104.

In FIG. 2, CO COa1, COa2 and COa3 are registered with CVS_{local} 104a. Similarly, CO COb1, COb2 and COb3 are registered with CVS_{local} 104b, and CO COc1, C0c2 and COc3 are registered with CVS_{local} 104c. CO communicate with their respective CVS_{local} 104 using their communication device.

On the other band, each of the CS, such as CS1, CS2 and CS3 primarily communicate with CVSₘₐᵢₙ 102 through their respective communication devices. Further, CS may be configured to communicate with CVS_{local} 104 in some embodiments.

In an embodiment, each CO is assigned a unique identification, which may be referred to as CO-ID. It shall be noted that a CO may have different or same CO-ID in each of the CVS_{local} 104 in which he is registered. However, care shall be taken to ensure that no two CO have the same CO-ID on a CVS_{local} 104. Further, each CS may be provided a unique ID, which may be referred to as CS-ID. Furthermore, each CVS_{local} 104 may be assigned a unique ID, which may be referred to as ORG-ID. It shall be noted that, each CVS_{local} 104 may be controlled by an institution/organisation, such as an education organisation, which has a stake in the credentials earned by CO. The organisation names to which the CVS_{local} 104 correspond to, and their respective ORG-ID may be made available to the public.

In a typical usage of system 100, a potential employer (CS) receives a resume for a job seeker (CO), wherein the job seeker might have submitted credential information, organisation to which the credential corresponds to and his CO-ID. The potential employer accesses a webpage in which the ORG-ID of the instant organisation is mentioned. The potential employer uses the CO-ID and ORG-ID to query system 100 to verify the authenticity of the credential information submitted by the job seeker.

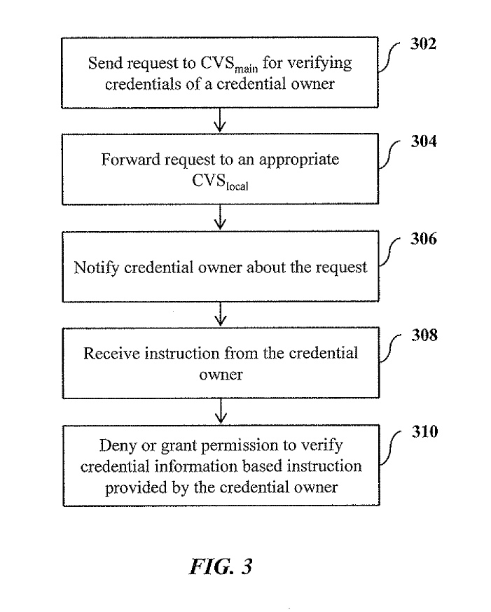

FIG. 3 is a flow chart illustrating a method for verifying credentials, in accordance with an embodiment. At step 302, a CS, such as CS1, sends a request to CVSₘₐᵢₙ 102 to enable verification of credential of a CO, for example, COa1. In the request, CS1 mentions CO-ID of COa1 and ORG-ID of the organisation to which the credential corresponds to. In an embodiment, CS1 receives the CO-ID from COa1, and the ORG-ID may be retrieved from a publicly available list of organisations and their respective ORG-Ids. Further, in an embodiment, the request includes a time frame during which CS1 desires to have access to credential information of COa1 Furthermore, the request may include scope of information corresponding to COa1, which CS1 wish to access.

Thereafter, at step 304, CVSₘₐᵢₙ 102 processes the request, and forwards the request to the appropriate CVS_{local} 104 based on the ORG-ID provided in the received request. In the instant example, if the ORG-ID corresponds to CVS_{local} 104a, then the request is communicated to CVS_{local} 104a.

Subsequently, CVS_{local} 104, which has received the request, verifies whether the CO whose CO-ID has been included in the request is registered with it. In case CO is not registered with the CVS_{local} 104, then the same is communicated to the CS who initiated the request. On the other hand, if the CO is registered, then CVS_{local} 104 notifies the CO that a request has been made to verify his credentials, at step 306. The notification may be sent using well known techniques, such as email, SMS, MMS or a notification to a mobile application corresponding to system 100, among other techniques. The notification can include the inputs provided by CS. Additionally, the notification can include information corresponding to the CS. It shall be noted that, CO may be enabled to communicate with system 100 to modify the address, such as, phone number or email address, at which the CO wishes to receive notifications. Well known techniques that are adopted to make such modifications may be adopted.

Upon receiving the notification, the CO responds to the request. Based on the response, system 100 receives instructions to take further actions corresponding to the request, at step 308.

In an embodiment, CO may respond to the request by providing instructions to grant access as sought by the CS in the request. Alternatively, CO may respond to the request by providing instructions to deny access to the CS for verifying his credentials. Further, instead of denying access, CO may modify the extent to which access shall be granted to CS for verifying credentials. The modifications, for example, may include, one or more of, time frame within which access shall be provided and scope of information (Ex: grades obtained, date of birth, place of origin, race and father's name) to which access shall be granted, among others.

The instant feature enables CO to control access to information corresponding to him, thereby addressing data privacy concerns that may arise normally during verification procedures.

System 100, based on the instructions received by the CO, denies or grants access to CO's credential information to the CS which initiated the request, at step 310.

It shall be noted that system 100, in an embodiment, enables CO and CS to communicate multiple time during the verification process through system 100. The communication may relate to negotiation between CO and CS with respect to what is desired and what is made available for verification.

In an embodiment, system 100 enables CO to pre specify a list of CS who may be allowed to verify their respective credential information. Similarly, system 100 enables CO to pre specify a list of CS who may not be allowed to verify their respective credential information. Further, the CO may specify, for each CS, who is allowed to verify credentials, one or more parameters, such as, time frame for allowing access and scope of access to information, among other parameters. In an embodiment, system 100 is configured to enable a CS to verify information of a CO, if the request parameters, such as, time frame and scope of access, defined by the CS in the request is within the specification provided by the CO for the instant CS.

In an embodiment, credential information, which is required for verification, of all the registered CO resides with systems corresponding to respective CVS_{local} 104. Hence, a person skilled in the art can appreciate the fact that since CVS_{local} 104 is controlled/owned by their respective institutes, they do not have to share the entire data set corresponding to all the registered CO with third party to enable verification of credentials. Instead, data is made available to CS when need arises, with the permission of the CO whose credential verification is sought.

It shall be noted that, the above feature addresses concerns corresponding to misuse of credential information data if it were to be residing/controlled by third part to enable credential verification.

Further, privacy concerns are addressed by enabling CO and CS to communicate with system 100 to enable the verification process only after they authenticate themselves to system 100.

In an embodiment well known public key cryptography techniques are adopted to securely enable the verification process. In the instant embodiment, each CVS_{local} 104 is assigned a public key, CVS_{local-public} and a private key, CVS_{local-private}. Similarly, CVSₘₐᵢₙ 102 is assigned a public key, CVS_{main-public} and a private key, CVSₘₐᵢₙ₋ₚᵣᵢᵥₐₜₑ. Further, each CS is assigned a public key, CS_{public} and a private key, CSₚᵣᵢᵥₐₜₑ. The aforementioned keys are used by the respective entities during the verification process.

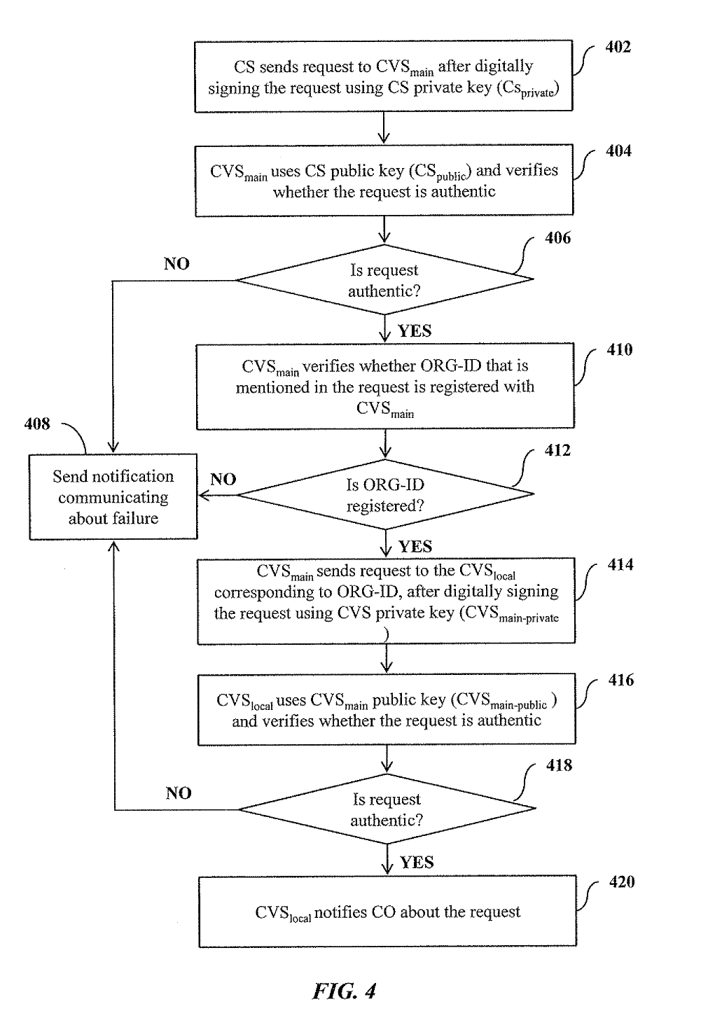

FIG. 4 is a flowchart illustrating a method to send a request to a CO for verifying his credentials, in accordance with an embodiment. A CS may send a request to verify credentials of a CO using a web interface. The CS may use the web interface to authenticate himself to system 100. Thereafter, at step 402, CS may submit a request to system 100, for verifying credentials of the CO. The request can include, for example, CO-ID, ORG-ID, time frame desired to access credential information and scope of information sought to be verified. The request is digitally signed by the CS, using its private key, CSₚᵣᵢᵥₐₜₑ. The digitally signed request sent by the CS is received by CVSₘₐᵢₙ 102. At step 404, CVSₘₐᵢₙ 102 uses, CS public key, CS_{public} to which it has access, and verifies whether the request is indeed originating from the registered CS. If, at step 406, CVSₘₐᵢₙ 102 determines that the request is not authentic, then the same is notified to the entity who initiated the request. On the other hand, if the request is determined to be authentic, then at step 410, CVSₘₐᵢₙ 102 verifies whether. ORG-ID mentioned in the request is registered with CVSₘₐᵢₙ 102. If at step 412, it is determined that ORG-ID is not registered, then the same is communicated to the CS. On the other hand, if the ORG-ID is registered, then at step 414, CVSₘₐᵢₙ 102 send the request to a CVS_{local} 104 corresponding to the ORG-ID. CVSₘₐᵢₙ 102 sends the request to CVS_{local} after digitally signing the request using CVS private key, CVSₘₐᵢₙ₋ₚᵣᵢᵥₐₜₑ. CVS_{local} 104 after receiving the request from CVSₘₐᵢₙ, verifies whether the request is originating from CVSₘₐᵢₙ 102, using CVSₘₐᵢₙ public key, CVS_{main-public}. If the authentication fails, then the same may be communicated to a concerned entity. On the other hand, if authentication if successful, then the CO to whom CO-ID relates to, is notified about the request, at step 420.

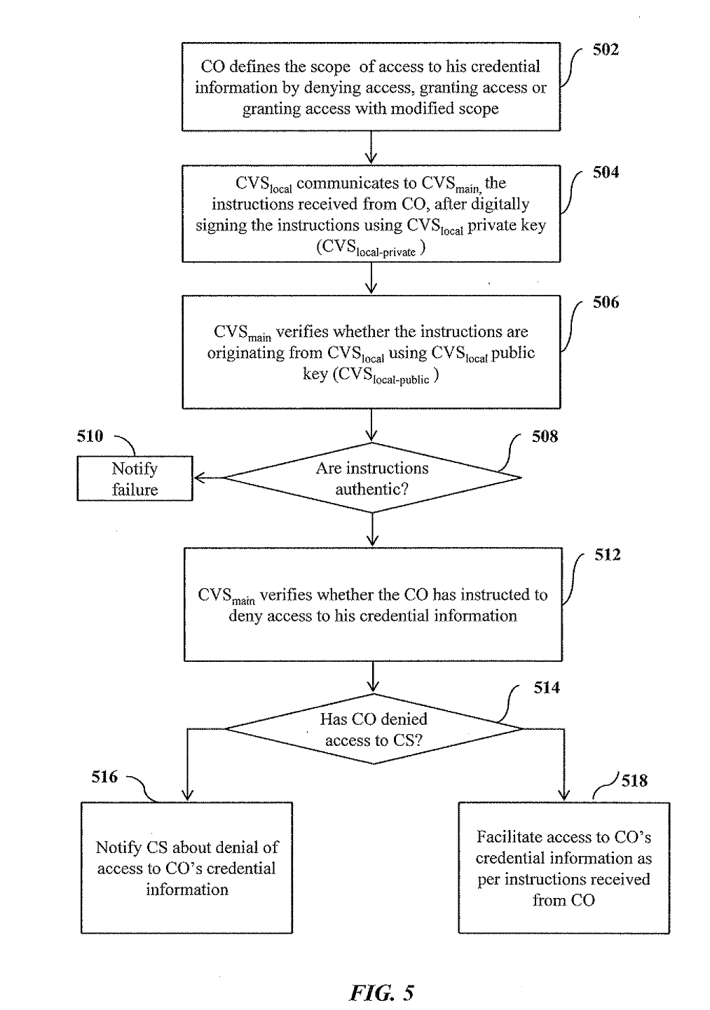

The CO, after receiving the notification, can take appropriate actions to influence access to his credential information. It shall be note that the notification can include the details of the CS who is requesting access, among other information included in the notification. FIG. 5 is a flow chart illustrating a method for receiving and processing instructions from the CO, in accordance with an embodiment. The CO, subsequent to receiving the notification, takes appropriate actions corresponding to the request after authenticating himself to the system 100. The CO, upon successful authentication, takes appropriate action at step 502. The actions taken by CO can include, denying access to his credential information to the CS, granting access as per the scope of access requested by the CS or modifying the scope of access. Modification of scope can include increasing the scope, decreasing the scope or a combination of both (Ex: scope increased for some field of information and decreased for other fields). The scope can include, for example, time frame for accessing the information, access to grades obtained during a specified time period and information relating to the character of the CO, among others.

The actions taken by the CO is communicated to CVS_{local} 104 as instructions. Thereafter, at step 504, CVS_{local} 104 communicates the instructions received from CO to CVSₘₐᵢₙ 102, after digitally signing the instructions using CVS_{local} 104 private key, CVS_{local-private}. CVSₘₐᵢₙ 102 after receiving the instructions from CVS_{local} 104, verifies, at step 506, whether the instructions are indeed originating from CVS_{local} 104, using CVS_{local} public key, CVS_{local-public}. If at step 508, it is determined that the instructions are not authentic, then at step 510, the same may be notified to an appropriate entity. On the other hand, if the instructions are determined to have been originated from CVS_{local} 104, then at step 512, CVSₘₐᵢₙ verifies whether CO has granted access to his credential to CS. If CO has denied access, then at step 516, the same is communicated to CS. However, if CO has granted access, then system 100 enables CS to access CO's credential information as per the instructions provided by CO.

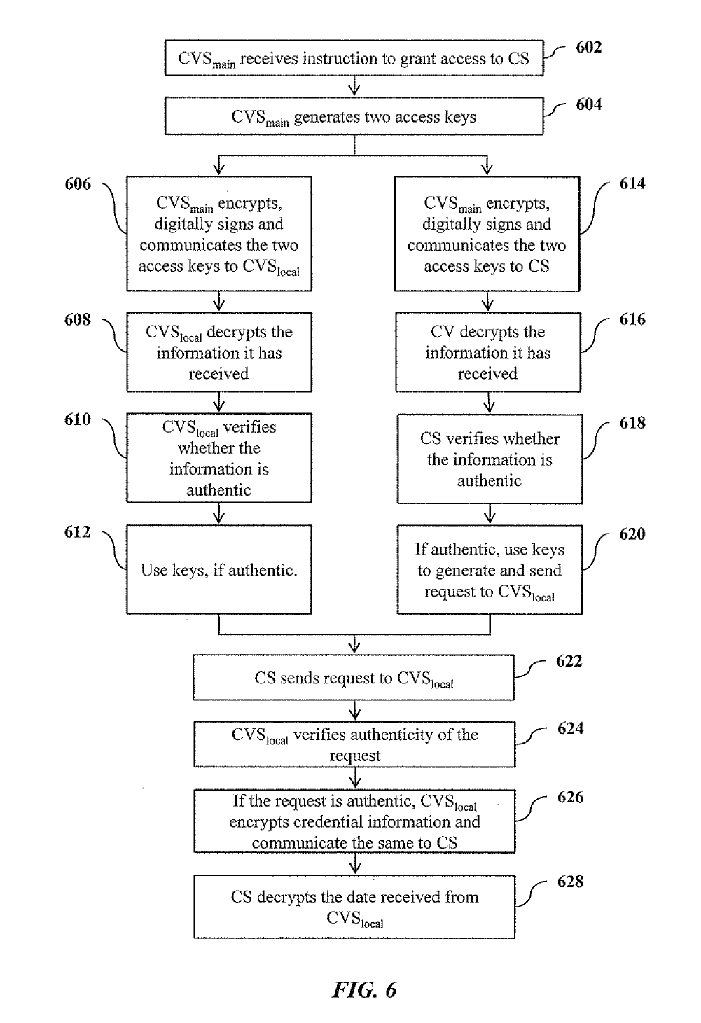

FIG. 6 is a flow chart illustrating a method for enabling CS to access credential information of CO, after the CO has granted access, in accordance with an embodiment. At step 602, CVSₘₐᵢₙ 102 receives instructions to grant access to CS. Subsequently, at step 604, CVSₘₐᵢₙ 102 generates two random access keys, CS_{public-access} and CS_{secret-access}. These keys will be used by the CS to access credential information of CO. Further, these keys may be unique to every verification request and may be valid over a time frame as instructed by the CO while granting permission to access.

CVSₘₐᵢₙ 102 communicates these keys to CVS_{local} 104 and CS. At step 606, CVSₘₐᵢₙ 102 sends the CS_{public-access} and CS_{secret-access} keys to CVS_{local} 104, after encrypting and digitally signing the same. CVSₘₐᵢₙ 102 carries out encryption using CVSₘₐᵢₙ private key, CVSₘₐᵢₙ₋ₚᵣᵢᵥₐₜₑ and CVS_{local} public key, CVS_{local-public}. Further, CVSₘₐᵢₙ 102 digitally signs the information that has to be communicated using CVSₘₐᵢₙ private key CVSₘₐᵢₙ₋ₚᵣᵢᵥₐₜₑ. At step 608, CVS_{local} 104 decrypts the information communicated by CVSₘₐᵢₙ 102 using CVSₘₐᵢₙ public key, CVS_{main-public} and CVS_{local} private key, CVS_{local-private}, and checks for the authenticity of the information. If the information received by CVS_{local} 104 is found to be authentic, then the same will be used in further steps of the verification process.

Similarly, at step 614, CVSₘₐᵢₙ 102 sends the CS_{secret-access} and CS_{public-access} keys to the CS after encrypting and digitally signing the same. CVSₘₐᵢₙ 102 carries out encryption using CVSₘₐᵢₙ private key, CVSₘₐᵢₙ₋ₚᵣᵢᵥₐₜₑ and CS public key, CS_{public}. Further, CVSₘₐᵢₙ 102 digitally signs the information that has to be communicated, using CVSₘₐᵢₙ private key CVSₘₐᵢₙ₋ₚᵣᵢᵥₐₜₑ. At step 618, CS decrypts the information communicated by CVSₘₐᵢₙ 102 using CVSₘₐᵢₙ public key and CS private key, CSₚᵣᵢᵥₐₜₑ, and checks for the authenticity of the information. If the information received by CS is found to be authentic, then the same will be used in further steps of the verification process.

At step 622, CS sends a request to CVS_{local} 104 to access credential information of CO. To send the request, CS generates an access token (AT) based on access keys, CS_{secret-access} and CS_{public-access}. Thereafter, CS digitally signs the request using CS private key, CS_{private,} and sends the request to CVS_{local} 104.

It shall be noted that, in light of this description, a person skilled in the art, may make modifications to the cryptographic techniques adopted in these embodiments.

At step 624, CVS_{local} 104 verifies the authenticity of received request using CS_{public}, and proceeds only if authentic. Once verified, at step 626, CVS_{local} 104 sends the required credentials to the CS by encrypting the same using the CVS_{local} private key, CVS_{local-private} and CS public key, CS_{public}.

At step 628, CS decrypts the information received from CVS_{local} using CVS public key, CVS_{local-public} and CS private key, CSₚᵣᵢᵥₐₜₑ.

It shall be noted that, in light of the foregoing description, a person skilled in the art may modify authentication and data security techniques, within the scope of the claims to enable credential verification.

It shall be further noted that a web interface corresponding to system 100 may be designed to initiate and facilitate simultaneous verification of credentials of plurality of credential owners across institutes who have a stake on the credentials earned by the credential owners.

It shall be further noted that in some embodiments, CVSₘₐᵢₙ may be forgone, and the functionality of CVSₘₐᵢₙ may be performed by appropriate CVS_{local}. Such modifications are within the scope of the claims.

The processes described above and illustrated in the drawings is shown as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus the scope of the invention should be determined by the appended claims and their legal equivalents rather than by the examples given.

What is claimed is:

1. A system for verifying credentials, the system comprising, a credential verification server and a plurality of credential verification local servers, wherein the system is configured to:
receive a request from credential seeker to verify credentials of a credential owner, wherein the request is received by the credential verification server;
forward the request to an appropriate credential verification local server among the plurality of credential, verification local servers, based on information included in the request;
notify the credential owner about the request, wherein the notification is sent by the credential verification local server;
receive instruction from the credential owner, wherein the instruction comprises at least one of, denying permission to verify credential information, granting permission to verify credential information as requested by the credential seeker and granting permission to verify credential information after modifying scope of access to information; and
provide access to the credential seeker to verify credentials of the credential owner based on the instruction received by the credential owner.

2. The system according to claim 1, wherein the request to verify credential comprises unique identification of the credential owner and unique identification of the credential verification local server.

3. The system according to claim 1, wherein the request to verify credential comprises at least one of time frame during which access to credential information is desired and scope of information to which access is sought.

4. The system according to claim 1, wherein each of the plurality of credential verification local servers has direct access to credential information of respective credential owners who are registered with it, and credential information sharing is enabled using credential verification server after receiving instructions from credential owners whose credential verification is sought by credential seekers.

5. The system according to claim 1, wherein credential seekers are registered with the system.

6. The system according to claim 1, wherein cryptographic access keys are generated by credential verification server to enable credential information to be communicated between the credential verification local server and the credential seeker.

7. The system according to claim 1, wherein public key cryptography technique is used to authenticate or encrypt communication between credential seekers and credential verification server.

8. The system according to claim 1, wherein public key cryptography technique is used to authenticate or encrypt communication between credential verification server and credential verification local servers.

9. The system according to claim 1, wherein public key cryptography technique is used to authenticate or encrypt communication between credential verification local servers and credential seekers.

10. The system according to claim 1, wherein the notification to the credential owner comprises information corresponding to the credential seeker.

11. The system according to claim 1, further configured to enable the credential owner to, predefine a list of credential seekers who shall be allowed to verify the credentials of the credential owner, and predefine a list of credential seekers who shall not be allowed to verify the credentials of the credential owner.

12. The system according to claim 11, wherein the credential owner is enabled to define the scope of access to credential information to each credential seeker present in the predefined list of credential seekers who shall be allowed to verify the credentials of the credential owner.

13. The system according to claim 1, further configured to enable the credential seeker and credential owner to negotiate scope of access to credential information for verification.

14. A method for verifying credentials, the method comprising:
receiving a request from credential seeker to verify credentials of a credential owner, wherein the request is received by a credential verification server;
forwarding the request to an appropriate credential verification local server among plurality of credential verification local servers, based on information included in the request;
notifying the credential owner about the request, wherein the notification is sent by the credential verification local server;
receiving instruction from the credential owner, wherein the instruction comprises at least one of, denying permission to verify credential information, granting permission to verify credential information as requested by the credential seeker and granting permission to verify credential information after modifying scope of access to information; and
providing access to the credential seeker to verify credentials of the credential owner based on the instruction received by the credential owner.

15. The method according to claim 14, wherein the request to verify credential comprises unique identification of the credential owner and unique identification of the credential verification local server.

16. The method according to claim 14, wherein the request to verify credential comprises at least one of time frame during which access to credential information is desired and scope of information to which access is sought.

17. The method according to claim 14, further comprising, providing each of the plurality of credential verification local servers, direct access to credential information of respective credential owners who are registered with it, and enabling credential information sharing using credential verification server after receiving instructions from credential owners whose credential verification is sought by credential seekers.

18. The method according to claim 14, further comprising enabling registration of credential seekers with the credential verification server.

19. The method according to claim 14, wherein notifying comprises, including information corresponding to the credential seeker in the notification.

20. The method according to claim 14, further comprising, enabling the credential owner to, predefine a list of credential seekers who shall be allowed to verify the credentials of the credential owner, and predefine a list of credential seekers who shall not be allowed to verify the credentials of the credential owner.

21. The method according to claim 20, wherein the credential owner is enabled to define the scope of access to credential information to each credential seeker present in the predefined list of credential seekers who shall be allowed to verify the credentials of the credential owner.

22. The method according to claim 14, further comprising, enabling the credential seeker and credential owner to negotiate scope of access to credential information for verification.
